(19) United States
(12) Patent Application Publication
(10) Pub. No.: US 2004/0047061 A1
(43) Pub. Date: Mar. 11, 2004

(54) Device and method for reading and/or recording audiovisual data on a disk and disk for such a device

(76) Inventors: Fabien Deschamps, Rennes (FR); Christophe Rabu, Bruz (FR); Pascal Maetz, Chevaigne (FR)

Correspondence Address: Joseph S Tripoli, Patent Operations-Thomson multimedia Licensing Inc, CN 5312, Princeton, NJ, 08543-0028, US

(21) Appl. No.: 10/250,407

(22) PCT Filed: Dec. 14, 2001
(86) PCT No.: PCT/EP01/14758

(30) Foreign Application Priority Data
Dec. 28, 2000 (FR) 00/17180

(51) Int. Cl. H04N 5/91; G11B 5/00

(52) U.S. Cl. 360/1; 386/46

(57) ABSTRACT

The invention relates to equipment for reading and/or recording audiovisual data on a disk intended to be read and/or recorded at constant angular speed, such as a hard disk (12), this equipment comprising a permanent memory (16) containing data for controlling the equipment and a random access memory (18) intended for loading with data contained in the permanent memory (16) for operating the equipment. The data needed to operate the equipment are stored in outer zones of the disk (12) and this equipment comprises means for loading these data in the random access memory (18) during an initialization period.

The invention relates to equipment for reading and/or recording data on a disk rotating at constant angular speed. It also relates to a method for recording a disk rotating at constant angular speed and to such a disk.

More particularly, it relates to a recorder for recording audiovisual data on disk at constant angular speed, such as a hard disk (magnetic disk).

A recorder of this type may be used to record television broadcasts. Since this recorder allows reading of zones already recorded, at the same time as it is recording, it may, for example, be used for deferred viewing of television broadcasts, that is to say that it is possible to view the start of the broadcast while the end of the broadcast is still being recorded on the disk.

Equipment of this type is similar to a computer, namely it comprises a permanent memory, such as a flash memory, which stores the software needed for its operation, such as software interfacing with a television receiver, compression and decompression software, for example software such as the MPEG2 video standard or of the Dolby standard for the audio part. When the equipment is powered on, this software is transferred to a random access memory controlled by a microprocessor. The advantage of the random access memory is that it can be quickly written and read, which allows the equipment to operate efficiently.

The purpose of the invention is to reduce the cost of such equipment without thereby impairing its performance.

To this end, the read and/or recording equipment according to the invention comprises a disk designed to be read and/or recorded and rotating at constant angular speed and on which data needed to operate the equipment is stored, which data are arranged in the outer zones of the disk.

Thus the use of the disk for the data (especially software) needed to operate the equipment reduces the size of the permanent memory and therefore its cost. Furthermore, since the data needed for operation must be loaded in the random access memory on starting up the equipment, and since these data are stored in the outer zone of a disk with constant angular speed, they are located in the zones for which the linear speed is the greatest, in other words, the zones for which the data are most quickly read. Thus, the times for transfer from the disk to the random access memory are minimized, which makes transfer times of, for example, about 0.7 seconds possible for software comprising 20 MB where the transfer speed in the outer zones is 30 MB per second. If this software were located in the inner zones, the transfer time would be about 1.5 seconds, all other things being equal, that is twice as long.

Under these conditions, the time for starting up the equipment is minimized.

To further reduce the transfer time, in a preferred embodiment of the invention, the data needed for operation, which are stored in the outer zones of the disk, are arranged over contiguous sectors so that the read head does not have to jump from one sector to a non-contiguous sector. This is because it is known that the information is distributed in sectors on disks. For example, in the hard disk standard, each sector comprises 512 bytes. If information other than data (software) needed for startup were stored in the same zone on the hard disk, reading startup data would require jumps from one sector to a non-contiguous sector. In fact, one jump lasts for about 10 ms, and the multiplication of such jumps would therefore lead to a not insignificant delay. Thus, by making provision to store only these startup data in the outer zones, the jumps and therefore the delays are avoided.

Equipment according to the invention may be connected to an antenna or to a television-broadcast decoder and also to a television receiver for viewing broadcasts.

This equipment may also form an integral part of a television-broadcast decoder.

It may also be integrated into a television receiver so as to constitute, for example, a recorder allowing the recording of broadcasts and the simultaneous reading of the same, broadcast or of pre-recorded broadcasts.

In brief, the invention relates to equipment for reading and/or recording audiovisual data on a disk designed to be read and/or recorded at constant angular speed, such as a hard disk, this equipment comprising a permanent memory containing data for controlling the equipment and a random access memory intended for loading with data contained in the permanent memory for operating the equipment. In this equipment, the data needed to operate it are stored in outer zones of the disk, the equipment comprising means for loading these data in the random access memory during an initialization period.

The data needed for real-time operation are stored on contiguous sectors of the outer zones of the disk.

The invention also relates to a disk, especially a hard disk, designed to be recorded and read at constant angular speed. This disk is split into at least two distinct zones, namely an outer zone for recording software or data which must be read quickly, and a zone for recording the actual data, such as audiovisual data.

In one embodiment, the disk comprises a third zone, the innermost zone, arranged so that the zone for recording the actual data is outside this third zone and designed for recording data which must be read less quickly than the data located in the outer zone.

The invention also relates to a method for recording data on a disk, especially a hard disk designed to be recorded and read at constant angular speed. This method is such that the disk is split into at least two distinct zones, namely an outer zone for recording software or data which must be read quickly and a zone for recording the actual data, such as audiovisual data.

Other characteristics and advantages of the invention will become apparent from the description of some of its embodiments, the description being given with reference to the appended drawings, in which:

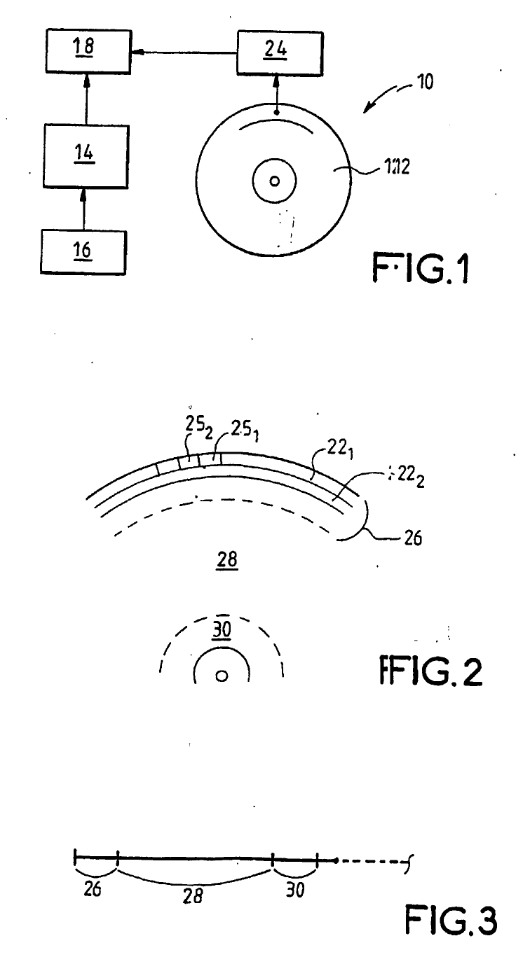

FIG. 1 is an overall diagram of a hard-disk recorder/reader according to one embodiment of the invention, and

FIGS. 2 and 3 are diagrams showing the various zones of a disk according to the invention.

In the example, the recorder 10 is designed to record audiovisual broadcasts such as television broadcasts received by a decoder (not shown). This recorder is of the hard-disk type, namely a magnetic disk of the type commonly used in computers. Thus, the disk 12 is, in this example, designed to rotate at a constant angular speed.

Just like a computer, the recorder comprises a microprocessor 14, a permanent memory 16 of the flash type and a random access memory 18 which is loaded when equipment operation starts, namely during an initialization period. This is because it is known that such a random access memory can be written and read in a minimum time, which allows fast operation of a computer or of a dedicated computer such as equipment for recording broadcasts or audiovisual data. However, such a memory is unable to store the data permanently. It is for this reason that the data needed to operate the equipment are stored in the permanent memory 16 of the flash type, hereinafter called the flash memory. Furthermore, according to the invention, the initialization data are stored on the disk 12 and, according to a significant arrangement, on the outermost tracks or cylinders 22₁, 22₂, etc. of the disk.

Thus, during the initialization period, the flash memory 16 is read using the microprocessor 14 so as to transfer the data into the random access memory (RAM) 18. The software data transferred from the flash memory 16 to the random access memory 18 make it possible in particular to access (interface) the disk. Then all the data needed to operate the recorder 10, and which are located on the outer tracks 22₁, 22₂ of the disk 12, are loaded in this memory 18 via an interface circuit 24.

The software which, on startup, must be placed in the random access memory 18 quickly and which is stored on the tracks 22₁, 22₂, etc. of the disk 12, is in particular that which is needed for the continuous operation of the equipment, such as video and audio decompression software allowing data which is compressed, received and possibly recorded on the disk to be read. If the equipment is designed to receive and record analogue audiovisual data, it is also possible to provide compression software.

For a disk rotating at constant angular speed, as is the case for a hard disk, it is particularly advantageous to place data which are to be loaded quickly in the memory 18 on the outer zones because these zones move past the read-write head at the highest speed, thus allowing faster reading than in the case of data written on zones further inwards.

Furthermore, it is known that, on a hard disk, the data are distributed over sectors 25₁, 25₂, each sector comprising the same number of bytes, for example 512 bytes, in the hard disk standard. Under these conditions, it is preferable to reserve the outer zone 26 (FIG. 3) exclusively for software and to write the software continuously onto the sectors so that there is no sector designed for other data. Thus, on reading the zone 26, in order to load it into the random access memory, the read head sees only successive sectors and does not have to jump from one sector to a non-contiguous sector. This is because such jumps would cause a delay which would be detrimental to the speed of loading into the random access memory 18.

It should be noted that this latter arrangement is applicable irrespective of the type of reader/recorder. Thus, if the disk is not at constant angular speed but at constant linear speed, it will be possible to arrange the software to be loaded quickly into the random access memory on any zone.

The invention also relates to a distribution of the data recorded on the disk 12, as shown in FIG. 2 and FIG. 3.

In this embodiment, the disk 12 is divided into three zones. The outer zone 26 comprises, as already mentioned above, the software to be loaded quickly, namely the encoder/decoder software. The middle zone 28, which has the largest surface area, is designed for recording and reading audiovisual data, namely data which must be read or written in real time. Finally, the inner zone 30 is designed for other data, for example data for deferred access which do not require a high read speed especially for software not in real time. Examples of software that may be located in the inner zone 30 are, for example, games software, internet data such as navigation data, an address directory or a browsing history file.

The advantage of placing audiovisual data to be read and to be recorded in a single zone 28 is that the distances to be travelled by the read/write head, when reading is carried out at the same time as recording, are minimized. This is because, in such equipment, a single head is used per disk face, and it is possible, in spite of there being just one head, to record and to read in different parts of the zone 28. However, the continuous back-and-forth movements of the read/record head from the read region to the record region cause delays which are detrimental both to reading and to recording. Placing the data to be read and to be recorded in a single zone, the other data being located in different zones 26 and 30, minimizes the distances travelled by the read head and therefore the time wasted by the transfers.

1. Device for reading and/or recording audiovisual data on a disk designed to be read and/or recorded at constant angular speed, such as a hard disk (12), this equipment comprising a permanent memory (16) containing data for controlling the equipment and a random access memory. (18) intended for loading with data contained in the permanent memory (16) for operating the equipment, characterized in that data needed to operate the equipment are stored in outer zones of the disk (12), the equipment comprising means for loading these data in the random access memory (18) during an initialization period.

2. Device according to claim 1, characterized in that the data needed for real-time operation are stored on contiguous sectors (251, 252) of the outer zones of the disk (12).

3. Device according to claim 1 or 2, characterized in that the data needed for real-time operation stored in outer zones of the disk (12) comprise at least data for controlling the operation of the equipment.

4. Device according to any one of the preceding claims, characterized in that the disk is divided into three zones, namely an external zone (26) comprising the data needed for operation, an intermediate zone (28) for recording the audiovisual data, and an inner zone (30) for recording the data for which the read and/or write speed may be slower than for the data located in the outer zone (26).

5. Disk, especially a hard disk, designed to be recorded and read at constant angular speed, characterized in that it is split into at least two distinct zones, namely an outer zone (26) for recording software or data which must be read quickly, and a zone (28) for recording the actual data, such as audiovisual data.

6. Disk according to claim 5, characterized in that it comprises a third zone (30), the innermost zone, arranged so that the zone for recording the actual data is outside this third zone and designed for recording data which must be read less quickly than the data located in the outer zone.

7. Method for recording data on a disk, especially a hard disk, designed to be recorded and read at constant angular speed, characterized in that this disk is split into at least two distinct zones, namely an outer zone (26) for recording software or data which must be read quickly and a zone (28) for recording the actual data, such as audiovisual data.

8. Method according to claim 7, characterized in that a third, innermost zone (30) is provided, placed so that the zone for recording the actual data is outside this third zone, and designed for recording data which must be read less quickly than the data located in the outer zone.
